(19) United States
(12) Patent Application Publication
(10) Pub. No.: US 2003/0090516 A1
(43) Pub. Date: May 15, 2003

(54) Method for producing an interface of a portal site, especially for transmitting data and for communication, whereby said interface can be personified

(76) Inventor: Karl-Ulrich Stein, Unterhaching (DE)

Correspondence Address: MORRISON & FOERSTER LLP, 1650 TYSONS BOULEVARD, SUITE 300, MCLEAN, VA, 22102, US

(21) Appl. No.: 10/240,849

(22) PCT Filed: Mar. 29, 2001
(86) PCT No.: PCT/DE01/01217

(30) Foreign Application Priority Data
Apr. 6, 2000 (DE) 100 17 223.7
May 25, 2000 (DE) 100 25 990.1

(51) Int. Cl. G09G 5/00

(52) U.S. Cl. 345/745

(57) ABSTRACT

The invention relates to a method according to which a portal site (10) for a user is automatically generated on a terminal (12). A request profile (16) of the respective user, terminal-specific parameters (18) and services which are available for the terminal (12) are detected. The selected services are subsequently allocated. In another embodiment, a portal site is automatically generated.

The invention relates to a method for creating a personifiable interface between a terminal associated with a subscriber and a plurality of services in at least one network, particularly services for data transmission and communication at least to some extent over the Internet.

Thus, DE 197 37 826 discloses an Internet server and a method for creating a web site which can be accessed by interested suppliers. However, this specification does not indicate any method for generating a portal site which is tailored to the specific requirements of the subscriber and which said subscriber can use to access various communication services.

DE 196 48 556 indicates an interactive data transmission system which provides Internet access via existing, analog telecommunication lines and using a modem, a mouse and a television or video recorder. This document also does not give any kind of instructions to a person skilled in the art for automatically creating a subscriber-specific portal site which affords voice transmission, such as telephoning, besides other services.

WO 00/04476 likewise indicates a terminal for electronic commerce and for communicating data and voice. This specification does not contain any instructions regarding the inventive method for creating a portal site either.

To date, network operators and the most common search machine operators have provided a portal site which afford other services besides the basic search function, for example searching for a particular term entered by the subscriber or for an address. These other services include presentation of the current news, address management, an appointments diary, communication by e-mail, and the like. Some suppliers allow the user to set up this portal site for personal requirements using modules which are offered. An example which may be mentioned at this juncture is Netscape's “mynetscape”.

However, practice has shown the need for a personifiable portal site with modules which covers all communication services—besides the known search and information services—which the subscriber can use in principle.

Such a personifiable portal site is of particular significance to the new mobile radio companies with Internet access.

The existing portal sites have the drawback that they cover only the services which are based on data transmission on the Internet or on the World Wide Web (WWW). Examples of these are: e-mail, link gathering from web sites found which are of interest to the respective subscriber, news, discussion groups on the WWW, chats, etc. They do not cover communication services which already existed before data transmission on the Internet, such as telephoning (POTS, Plain Old Telephone Service, analog telephony) or the function of the answering machine, faxing or television, etc. This is explained by the history of the origins of portal sites, which are based, in principle, on communication or generally on data transmission via the WWW. Services which have existed to date, and to some extent services which have already existed for a long time, have therefore not been integrated.

To integrate further services, such as telephoning or, generally, VoIP (voice over IP), there was previously the difficulty that two fundamental network systems, namely a circuit-switched network and a packet-switched network, need to be combined. The creation of the packet-based multimedia communication system has made this possible, however. Thus, a PC with the appropriate configuration (sound card, microphone, appropriate network access, etc.) can likewise be used for telephoning over the Internet. To date, there has not been a portal site, particularly a method for generating a subscriber-specific portal site, which comprises the VoIP service.

It is therefore an object of the present invention to provide a method in which a personifiable graphical user interface is created on a subscriber's terminal for various services for data transmission and communication, particularly communication with other subscribers over the Internet, and which additionally comprises the service of telephoning. This is intended to take into account all the subscriber's technical options.

The invention achieves this object by means of the method mentioned in the introduction, which has the following steps:

a) a request profile for the subscriber is recorded,

b) technical, communication-related characteristic variables are recorded electronically and/or manually,

c) the request profile is associated with the services on the basis of the characteristic variables,

d) the subscriber-specific interface is created on the basis of the preceding steps.

Advantageously, the inventive method can be used to combine all the technical options for communication including telephoning—(telephone, fax, e-mail, videoconferencing, videophoning, etc.) centrally on a PC, which means that before the subscriber undertakes planned communication, he does not first need to decide which appliance (PC, POTS, FAX or the like) he needs to access. In fact, the subscriber has previously had to decide whether he wishes to choose the telephone or another service which he gets using a specific terminal or a specific application with specific hardware and software on the PC and, further, via his personal portal page on the Internet. These technical communication channels have now been combined centrally.

In one embodiment of the invention, the interface is visualized. If the interface is visualized on an individual portal site, for example, the subscriber can use any computer having Internet access to access it and thus advantageously becomes independent of the local situation of the appliance.

In one preferred embodiment of the invention, the method relates to the automatic and individual generation of a portal site for a subscriber without his needing to concern himself with the programming in Java or HTML for generating a browser page and, for this purpose, needing to know the technical parameters of his terminal and of the latter's peripheral area (such as type of terminal, software installed, network connection, provider, etc.). In the case of the inventive system, these data are recorded automatically in one advantageous embodiment. The subscriber need merely indicate his preferred communication channels and the services he desires—such as: telephone (type of telephone: with/without AB, telephone directory, etc.), e-mail, search engines, address management, etc. The method then takes the recorded data as a basis for automatically generating a personified interface in the form of a portal site which provides the subscriber with the channels he requires (also called boxes, which refer to various services).

It is also possible that, on account of the opportunities to use the computer's memory and CPU, appropriate software applications can be used which select, by way of example, the cheapest rate and the best network for specific communication (e.g.: a telephone call).

The inventive method's portal site offers, by way of example: telephone, fax and related services and also advantageous refinements thereof with various supplementary functions. Thus, the channel for telephoning can have the following services which have been preselected by the subscriber: telephone number management, answering machine function, selection of the cheapest rate for the desired call at the desired time, various types of telephone, such as radio telephone, added-feature telephone, etc., and any other functions which are common to date.

Another particularly preferred embodiment comprises a method step for accelerated display of this portal site when the system is started up so that the subscriber does not first need to wait until all the system's units have been started up when he wishes to access only the portal page for further selection. This is achieved by virtue of a chip, specifically designed for this purpose, on a microcomputer with a memory (static or dynamic), a CPU, an I/O unit and a bus starting up only the components which are relevant to the portal page and allowing them to be operated by means of a buffer system, for example, and buffer-storing them therein until the required operating system components have been loaded, in order to be able subsequently to forward the content of the buffer system to the respective components of the operating system. A related system is the “On-Now” system from Microsoft, in which the system is kept in a kind of standby mode or power down mode until an actuation function is selected, whereupon only the initially required operating system components are started up in order to provide the user with faster access.

In one particularly preferred embodiment of the invention, the method involves creating an interface between a subscriber and a plurality of services, particularly for telephoning in a portal site adapted to a specific subscriber. To this end, the subscriber merely indicates his individual parameters (type of available telephone(s) with associated interfaces, and also the other technical appliances and the desired further functionalities, such as answering machine function, selection of the cheapest connection, etc., see list above). On the basis of these data, the inventive method automatically generates an interface, particularly in the form of a browser or portal page, which allows the subscriber to select from the various technical options. In this way, the interface visualizes, in particular, all VoIP options and also the option of IP telephony (telephoning over the Internet) either using two PCs with appropriate equipment or using telephones with Ethernet interfaces. The subscriber is thus provided with the advantage that, particularly in the case of long-distance calls, he has to pay only the local rate to the provider's dial-in node and not the usual telephone charges.

In addition, the inventive method affords the great advantage that the subscriber is not confronted by information for configuring the system. This is significant because, particularly in the case of VoIP, there are such a large number of standards which would certainly need to be known in addition to configuration data in order to produce a personal portal page manually but which the method in this case automatically reads and records from system configuration files or indirectly from the information about the installed driver in operating system files.

Thus, Microsoft originally introduced the TAPI standard (Telephony Application Program Interface), and Novell initially introduced the TSAPI (Telephony Services Application Programming Interface). In the meantime, however, there are such a large number of standards and interfaces which complicate an overview and classification of the system.

The method supports the trend in the development of browser-based front end systems, so that the functionality of a browser is extended such that it is virtually equivalent to a conventional operating system. Furthermore, the method can be regarded a further large step in the development toward “integrated messaging”, which combines communication channels such as e-mail, fax, voicemail and telephone in an integrated communication system in a user-friendly manner.

This technology also advantageously allows voice messages to be read from a buffer which is on the local disk, on an LAN server or on a WWW server, with—in a similar manner to in the case of e-mail—a “Subject” field allowing specific messages to be read selectively, which is fundamentally impossible with POTS.

Of particular significance is the inventive personifiable portal site with telecommunication services for the new mobile radio terminals. This could be the page which, in principle, appears immediately after turning on and synoptically presents Internet and communication services for use. In this context, one or more users of a terminal can also configure a plurality of pages which can be selected on the basis of person or situation. The situations can be, by way of example, “mobile phone operation”, car operation, hands-free operation or desk operation.

An alternative embodiment of the present invention which is found to be very advantageous in practice involves the interface not being a portal site for Internet communication but rather a—preferably browser-based—general reference page. This reference page supports the user when selecting applications in various areas which are available to him locally or over a network.

Other advantages of the invention and a particular embodiment having the features thereof are illustrated in the detailed description of the figures below. In the figures:

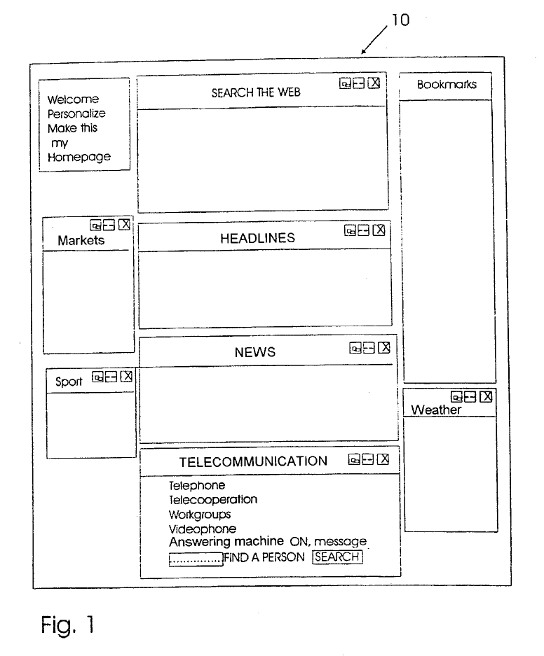

FIG. 1 shows a schematic illustration of a portal site which has been generated on the basis of the inventive method,

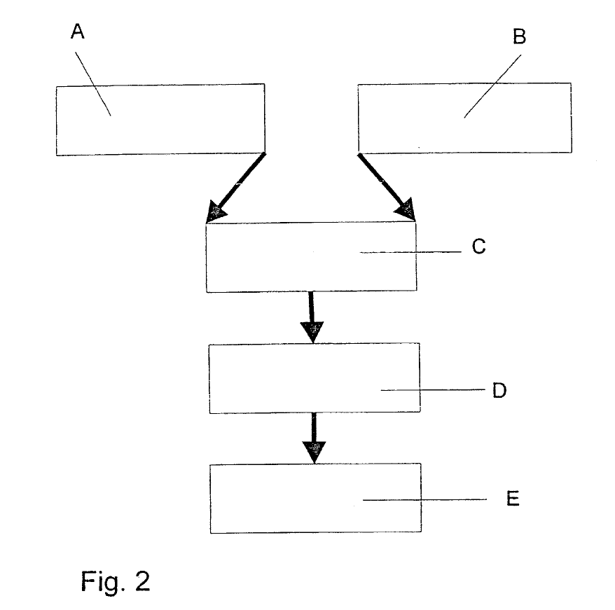

FIG. 2 shows a flowchart of the inventive sequence in a preferred embodiment.

The general sequence of the inventive method is presented briefly below by way of introduction and with reference to FIG. 2.

In a first step a, a request profile 16 for a subscriber's communication is recorded over the Internet. For this purpose, a specific mask is conceivable. This requires the subscriber merely to indicate his preferred communication and data transmission wishes (telephone, search engine, link directory, address management, fax, etc.).

In a step which is denoted generally by b, all the technical characteristic variables 18 of a terminal 12 are recorded by the method. This involves recording the following data: IP address of the terminal 12 (if fixed), access to the Internet, protocols used, transmission bandwidth available, memory, existing software, for example for supporting video conferences, picture transmission, voice transmission, etc.

On the basis of these data 16, 18, step c then determines whether the characteristic variables 18 of the terminal 12 with their network peripheral area allow support of the desired functions. If so, the individual items from the request profile 16 are associated with the available services, and a specific portal site 10 is generated for the respective user in step d. This portal site 10 is displayed in step e on the screen for the terminal 12. The portal site 10 comprises a plurality of communication channels 20, such as a channel for telecommunication 14, which includes services such as telephoning with or without an answering machine function, videoconferencing, picture transmission, e-mail, etc. Furthermore, the portal site 10 preferably comprises a further channel for search engines for searching on the Internet and a channel for link gathering or a channel for e-commerce. Advantageously, the portal site 10 can be configured by the subscriber according to his respective requests and demands and can be stored.

With this method, the communication appliance, for example a telephone, which can be selected in a telecommunication channel 14 on the portal site 10, is produced only virtually. Depending on the installed software, this allows a plurality of IT services to be provided using various appliances, with arbitrarily selectable and configurable functionality (see above, for example with: answering machine, voicemail, time announcement for a call, radio telephone, videophone, etc.). In addition, the subscriber has the advantage that he can use an appropriately equipped computer with Internet access to manage and execute all of his messaging from anywhere in the world, and not just subdivisions of said messaging, such as communication by e-mail, so that the telecommunication division, in particular, has to remain excluded. This affords the fundamental advantage that he does not need to familiarize himself with new interfaces again and again, but rather can always work with his private, personally tailored start page, which further increases the user-friendliness of the system and reduces errors. He can thus also pick up his VoIP messages and can reply to them if appropriate. For this purpose, he can also provide his recorded voice message with a time stamp for the purpose of buffer-storing it in a buffer until the time stamp expires in order to send it at a later time.

By integrating all the communication services in one portal site 10, it becomes possible to combine various communication options (voice, writing, picture, video, etc.) as desired. This makes it possible, for the first time, to reply to specific messages using services which are optimally designed for the specific case. If, by way of example, a subscriber receives a VoIP message from another subscriber and wishes to send written confirmation of receipt of this message together with his response, then he can usefully control the sending of this message by e-mail or another service using one and the same communication site.

One particularly advantageous embodiment involves the use of a terminal which is compatible with the H.323 standard as the terminal 12. This standard has been developed in order to be able to ensure network compatibility, so that loss-free and error-free transfer between the lines in the IP network and telephone network is ensured. This is necessary particularly in systems such as the present one which are based on a plurality of different networks (which include, by way of example, combined voice and data traffic/services). The terminals can thus be, as alternatives, telephones with Ethernet access, PCs with appropriate software equipment or “gatekeepers” in another IP network. Besides the transmission of voice, these H.323-compatible appliances can also perform other services, such as video transmission and conference systems. The inventive method thus permits any combination of intercommunicating terminals 12: from PC to PC, from normal telephones and/or fax machines to PCs, and connection over a pure IP network.

Preferably, the method also involves a step for structuring the services selected by the method and combines them into logical units in order to facilitate operation for the subscriber. This structuring is performed using “channels”. The invention thus comprises a method for automatically generating a portal site with at least one communication channel 20 which provides the option of voice transmission (e.g.: telephoning).

This provides the subscriber with the advantage that, when his personal, individual portal site 10 has been generated once in accordance with the invention, he can always access the same stock of data and can work with the same user interface. This is significant particularly for business people who do not always work on the same computer but can nevertheless use their definite and comprehensive communication options.

1. A method for creating a personifiable interface between a terminal (12) associated with a subscriber and a plurality of services in at least one network, particularly services for data transmission and communication at least to some extent over the Internet, which has the following steps:
a) a request profile (16) for the subscriber is recorded,
b) technical, communication-related characteristic variables (18) are recorded electronically and/or manually,
c) the request profile (16) is associated with the services on the basis of the characteristic variables (18),
d) the subscriber-specific interface is created on the basis of the preceding steps.

2. The method as claimed in claim 1, characterized in that the interface is visualized.

3. The method as claimed in claim 1 or 2, characterized in that the network is a circuit-switched network and/or a packet-switched network.

4. The method as claimed in one of the preceding claims, characterized in that the interface is a graphical user interface, particularly a portal site (10), for the subscriber to communicate with other subscribers and/or entities over the Internet.

5. The method as claimed in one of the preceding claims, characterized in that the data transmission is transmission of written and/or voice and/or video and/or picture data.

6. The method as claimed in one of the preceding claims, characterized in that the terminal (12) is an H.323 terminal.

7. The method as claimed in one of the preceding claims, characterized in that the interface is based on the RTP (Realtime Transport Protocol) and/or on the TCP (Transmission Control Protocol).

8. The method as claimed in one of the preceding claims, characterized in that the generated interface comprises at least one communication channel (20).

9. The method as claimed in claim 8, characterized in that generation of the interface includes all association options, which means that the subscriber has the option of choosing between a plurality of services within the communication channel (20).

10. The method as claimed in one of claims 8 or 9, characterized in that the communication channel (20) comprises at least one IT service.

11. The method as claimed in one of the preceding claims, characterized in that the recorded characteristic variables (18) are characteristic variables about the terminal (12), about the peripheral area thereof and about available services, in particular for data transmission.

12. The method as claimed in one of the preceding claims, characterized in that the interface is visualized via a browser.
